(19) United States
(12) Patent Application Publication
(10) Pub. No.: US 2002/0011029 A1
(43) Pub. Date: Jan. 31, 2002

(54) Door inner panel assembly

(76) Inventors: Mark Graham Lawrie, Lion en Sulias (FR); Yann Le Gallo, Orleans (FR); Pascal de Vries, Sandillion (FR); Klaus B. Wilhelm Blume, Frankfurt (DE); Charles Berry Hopson, Lebanon, TN (US); Herve Laurandel, St. Claire (FR); Simon Blair Dobson, Kent (GB); Damlen Cabanne, Fountainebleau (FR)

Correspondence Address: CARLSON, GASKEY & OLDS, P.C., 400 WEST MAPLE ROAD, SUITE 350, BIRMINGHAM, MI, 48009, US

(21) Appl. No.: 09/915,197

(22) Filed: Jul. 25, 2001

(30) Foreign Application Priority Data
Jul. 25, 2000 (GB) 0018103.2

(51) Int. Cl. B60J 5/04

(52) U.S. Cl. 49/502

(57) ABSTRACT

A door inner panel assembly including a door inner panel and a window regulator drive means, the window regulator drive means having a drive portion and an output shaft projecting from the drive portion, the inner panel having an abutment portion for co-operation with the drive portion and a shaft support portion for co-operation with a portion of the shaft remote from the drive portion, the abutment portion and shaft support portion being integrally formed from the same material.

### BACKGROUND OF THE INVENTION

The present invention relates to door inner panel assemblies and in particular door inner panel assemblies for use in automobiles.

Known door inner panel assemblies include a door inner panel and a window regulator drive means such as a window regulator drive motor or a manual drive means. The drive means operate to raise and lower an associated window glass.

However, known door inner panel assemblies include several components which are complicated and time consuming to assemble.

### SUMMARY OF THE INVENTION

An object of the present invention is to provide an improved form of door inner panel assembly.

Thus according to the present invention there is provided a door inner panel assembly including a door inner panel and a window regulator drive means, the window regulator drive means having a drive portion and an output shaft projecting from the drive portion, the inner panel having an abutment portion for co-operation with the drive portion and a shaft support portion for co-operation with a portion of the shaft remote from the drive portion, the abutment portion and shaft support portion being integrally formed from the same material.

According to a further aspect of the present invention there is provided a method of providing a door inner panel assembly including a door inner panel and a window regulator drive means comprising the steps of providing a window regulator drive means having a drive portion and an output shaft projecting from the drive portion, providing an inner panel having an abutment portion for co-operation with the drive portion and a shaft support portion for co-operation with a portion of the shaft remote from the drive portion, positioning the window regulator drive means relative to the door inner panel via at least one location feature of the panel, and securing the window regulator drive means relative to the door inner panel, in which the abutment portion and shaft support portion are integrally formed from the same material.

### BRIEF DESCRIPTION OF THE DRAWINGS

The present invention will now be described, by way of example only, with reference to the accompanying drawings in which:

FIG. 1 is an isometric view of part of a door inner panel assembly according to the present invention;

FIG. 2 is a sectional view of part of FIG. 1; and

FIG. 3 is a sectional view of part of FIG. 1.

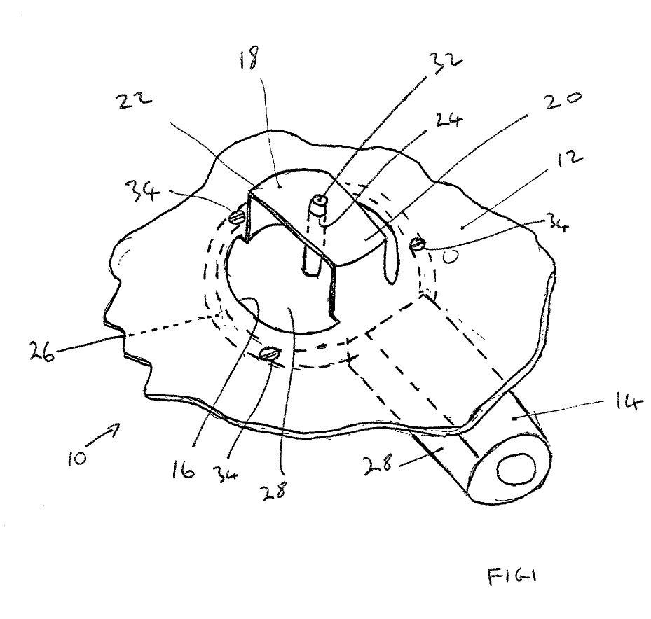

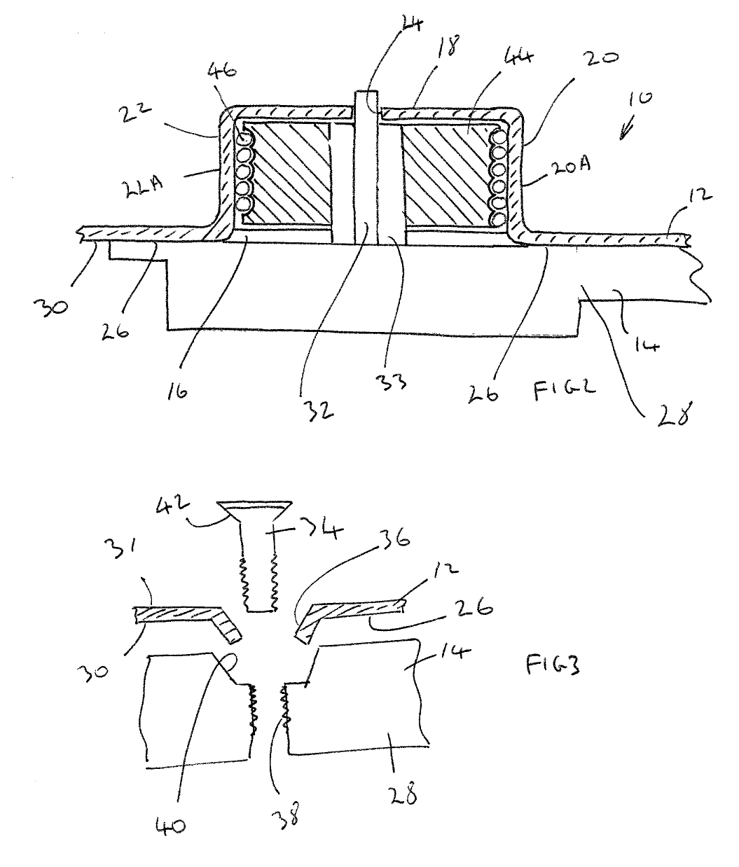

### DETAILED DESCRIPTION OF THE PREFFERED EMBODIMENT

With reference to the figures there is shown a door inner panel assembly 10 including a door inner panel 12 and a window regulator drive means, in the form of a window regulator motor 14.

In this case door inner panel 12 is in the form of a module mounting plate (also known as a carrier plate) upon which is mounted the window regulator motor, door latches (not shown) and a loud speaker (not shown). The door inner panel 12 is secured in a relatively large aperture of the inside of an associated door.

However, in further embodiments, the door inner panel of the present invention can comprise the door inner skin which is connected to the door outer skin, with various components such as latches and loud speakers being independently attached thereto.

The door inner panel is made from sheet material, in this case sheet steel and includes an aperture 16 and a bridge portion 18 integrally formed therewith via a pressing or stamping process. Bridge portion 18 includes a first upstanding leg 20 of L shape and a second upstanding leg 22 also of L shape.

Situated between the adjacent portions of the first and second upstanding legs is a shaft support portion in the form of a hole 24.

Adjacent aperture 16 is an abutment portion 26 of the door inner panel, against which the window regulator motor is secured.

The window regulator motor 14 includes a drive portion in the form of a body 28 which is situated on a first side 30 of the door inner panel.

An output shaft 32 projects from the body 28 through aperture 16 and also through hole 24. Output shaft 32 is rotationally fast with body 28 and acts a fixed axle for driven hub 33.

However, in further embodiments the output shaft itself could be rotationally driven by the window regulator motor.

The window regulator motor is secured to the door inner panel by three screws 34 which past from the second side 31 through fixing holes 36 into the threaded holes 38 of the window regulator body.

In this case holes 36 are conically formed and co-operating with a conical recess 40 of the threaded holes 38 and also co-operates with the conical head 42 of the screws 34.

The conical form of fixing holes 36 acts in co-operation with the conical recesses 40 to locate the body 28 in the correct position relative to the door inner panel 12. Subsequent insertion of the screws 34 ensures that the body is secured to the body inner panel against the abutment portion 26.

It should be noted that hole 24 supports a portion of shaft 32 remote from body 28. Furthermore the first and second upstanding legs are provided substantially diametrically opposite to each other with regard to the axis of the shaft 32.

A window regulator drum (only shown on FIG. 2 for clarity) is secured rotationally fast to the driven hub 33. A window regulator cable 46 is wrapped around the periphery of the drum such that operation of the window regulator motor causes the driven hub and hence drum to rotate which results in lifting or lowering of a cursor attached to the cables, the cursor carrying a window glass.

In particular the aperture 16 is large enough to allow the drum to pass through the aperture during assembly of the window regulator motor and drum on to the door inner panel.

It can be seen that the shaft support portion assists in supporting the shaft 32 when it is being driven by the window regulator motor 14. Furthermore side portions 20A and 22A of first and second upstanding legs 20 and 22 are positioned relatively closed to the periphery of the drum such that turns of the cable around the drum are retained in their correct drum groove.

In further embodiments the drive means could comprise a manual drive means instead of a window regulator motor. Furthermore a gear could be rotatably mounted on the shaft which acts as a fixed axle, which gear operates to rotate a window regulator sector.

In particular the door inner panel can be made from sheet material which is preferably sheet steel though in further embodiments this need not be the case. A particularly cost effective method of producing a door inner panel is to press or stamp the bridge portion 18, though in further embodiments this need not be the case.

In order to ensure that the drive means is secured to the door inner panel in the correct position such that the shaft 32 aligns with the hole 24, location features such a conical fixing holes 36 can be provided in the panel. When manufacturing these holes it is advantageous to provide a stamping tool which locates off the hole 24 whilst a finishing coining process is applied to the conical fixing holes 36. Alternatively where the conical fixing holes 36 are finished prior to hole 24, it is preferable to locate the tool which finishes hole 24 off the conical fixing holes 36.

In a further method, it is possible to finish both the conical fixing holes 36 and the hole 24 in a single process, thus ensuring that the tolerances on the positions of these holes is minimised.

The invention has been described in an illustrative manner, and it is to be understood that the terminology that has been used is intended to be in the nature of words of description rather than of limitation. Obviously, modifications and variations of the present invention are possible in light of the above teachings. It is, therefore, to be understood that within the scope of the appended claims the invention may be practiced otherwise than as specifically described. CLAIMS

What is claimed is:

1. A door inner panel assembly comprising: a door inner panel and a window regulator drive member, the window regulator drive member having a drive portion and an output shaft projecting from the drive portion, the inner panel having an abutment portion for cooperation with the drive portion and a shaft support portion for co-operation with a portion of the shaft remote from the drive portion, the abutment portion and shaft support portion being integrally formed from the same material.

2. The door inner panel assembly as defined in claim 1 in which the drive member is in the form of a window regulator motor.

3. The door inner panel assembly as defined in claim 1 in which the drive member is in the form of a manual drive member.

4. The door inner panel assembly as defined in claim 1 including a window regulator cable drum is secured on the shaft where the drum is positioned between the drive portion and the shaft support portion.

5. The door inner panel assembly as defined in claim 1 including a window regulator gear is secured on the shaft where the gear is positioned between the drive portion and the shaft support portion.

6. The door inner panel assembly as defined in claim 1 wherein the drive portion is mounted on a first side of the door inner panel and the panel includes an aperture substantially in a plane of the abutment portion through which the shaft can pass.

7. The door inner panel assembly as defined in claim 6 wherein a window regulator cable drum is secured on the shaft where the drum is positioned between the drive portion and the shaft portion and the window regulator drum can pass through the aperture.

8. The door inner panel assembly as defined in claim 6 wherein a window regulator gear is secured on the shaft where the gear is positioned between the drive portion and the shaft support portion and the regulator gear can pass through the aperture.

9. The door inner panel assembly as defined in claim 1 in which the shaft support portion is secured relative to the abutment portion by at least a first upstanding leg.

10. The door inner panel assembly as defined in claim 9 in which the shaft support portion is further secured relative to the abutment portion by a second upstanding leg position substantially opposite the first upstanding leg.

11. The door inner panel assembly as defined in claim 9 wherein a window regulator cable drum is secured on the shaft where the drum is positioned between the drive portion and the shaft support portion in which portions of the first and/or second legs act as cable guides for the cable drum.

12. The door inner panel assembly as defined in claim 10 wherein a window regulator cable drum is secured on the shaft where the drum is positioned between the drive portion and the shaft support portion where portions of the first and/or second legs act as cable guides for the cable drum.

13. The door inner panel assembly as defined claim 1 in which the door inner panel is formed from a sheet material.

14. The door inner panel assembly as defined in claim 13 in which the sheet material is a sheet metal such as sheet steel.

15. The door inner panel assembly as defined in claim 13 in which the door inner panel is pressed or stamped to provide regions for the shaft upper portion.

16. The door inner panel assembly as defined in claim 14 in which the door inner panel is pressed or stamped to provide regions for the shaft upper portion.

17. A method of providing a door inner panel assembly including a door inner panel and a window regulator drive member comprising the steps of providing a window regulator drive member having a drive portion and an output shaft projecting from the drive portion, providing an inner panel having an abutment portion for co-operation with the drive portion and a shaft support portion for co-operation with a portion of the shaft remote from the drive portion, positioning the window regulator drive member relative to the door inner panel via at least one location feature of the panel, and securing the window regulator drive member relative to the door inner panel, in which the abutment portion and shaft support portion are integrally formed from the same material.

18. The method as defined in claim 17 including the step of providing a finishing tool and locating the finishing tool off one of the location features or shaft support portion and providing a finishing operation on the other of the location feature or shaft support portion.

19. The method of claim 17 including the step of providing a finishing tool which provides a finishing operation on the shaft support portion and at least one of the fixing features.

20. The method of claim 17 in which the location features also acts as a fixing feature to secure the door inner panel to the window regulator drive member.

21. The method of claim 18 in which the location features also acts as a fixing feature to secure the door inner panel to the window regulator drive member.

22. The method of claim 19 in which the location features also acts as a fixing feature to secure the door inner panel to the window regulator drive member.
